(19) United States
(12) Patent Application Publication
(10) Pub. No.: US 2004/0206022 A1
(43) Pub. Date: Oct. 21, 2004

(54) Casing, door or window frame and method for producing the same

(75) Inventor: Giorgio Panto, Treviso (IT)

Correspondence Address: MODIANO & ASSOCIATI, Via Meravigli, 16, MILANO, 20123, IT

(73) Assignee: PANTO S.P.A.

(21) Appl. No.: 10/821,972

(22) Filed: Apr. 12, 2004

(30) Foreign Application Priority Data
Apr. 15, 2003 (IT) PD2003U000033

(51) Int. Cl. E06B 1/04

(52) U.S. Cl. 52/204.1; 52/212

(57) ABSTRACT

A frame for casings, doors or windows and the like, comprising a base framework constituted by at least two wood layers mutually glued; each layer is formed by at least one longitudinal series of wood tiles mutually connected by so-called finger joints obtained from wood boards without wood imperfections; the leading edge of each wood tile being shaped to form wedge-like teeth, and the trailing edge of the tile being shaped complementarily to the head; the leading and trailing edges of several wood tiles are joined by adhesive, to form a longitudinal series of wood tiles of preset length that is planed and calibrated and composed with adhesive, side by side and overlapped so as to form the frame.

The present invention relates to a frame for casings, doors or windows and the like.

In particular, the present invention can be applied to casings and to the corresponding sashes of windows, doors, doors with door mounting frame, front doors, sliding doors or windows, center-hung sashes, and shutters of various kinds, such as matchboard shutters, Venetian-style shutters, open/closed slat shutters, et cetera.

The present invention also relates to a method for manufacturing frames for casings, doors or windows and the like.

### BACKGROUND OF THE INVENTION

In Italy, the wood sector is a highly important element in terms of economy and employment.

However, like other production sectors, the shortage of raw material forces the importing of large quantities of wood from other European and non-European countries.

The results of the national forestry inventory published in the past have clearly indicated that in Italy the problem is not so much the extent of the wooded area but rather the suitability of its forests for production.

Italian forests in fact mostly produce assortments of limited commercial value (material for shredding, wood for burning, wood for poles and stakes, et cetera) and are able to meet only to a limited extent the demand for high-quality material suitable for high-value uses such as casings and doors or windows.

The situation prospected at present and for the near future is therefore a high domestic availability of small-size, low-quality wood.

From this standpoint, therefore, producing casings and doors or windows with high-quality wood is extremely onerous.

Moreover, currently commercially available casings and doors or windows are constituted by frames that are formed by means of a single block of wood or optionally by means of boards so as to form two or more longitudinal layers that are mutually bonded by gluing.

In order to give the frame an acceptable geometric and structural stability, rigidity and strength, the wood of which it is made must be subjected to particular treatments (for example long drying periods), which are expensive in terms of process, tied-up capital, and the risks of fire that can arise from storage.

As mentioned, these treatments can achieve only an acceptable stability and strength, and do so as the quality of the wood used increases.

It is therefore evident that the use of low-quality wood, despite having a low cost (in view of its great abundance on the Italian territory), is often less than ideal.

### SUMMARY OF THE INVENTION

The aim of the present invention is to provide a frame for casings, doors or windows and the like that allows to solve the drawbacks noted in the production of known types of frame for casings and doors or windows.

Within this aim, an object of the present invention is to provide a frame for casings, doors or windows and the like that is extremely rigid and strong and highly stable from a geometric and structural standpoint.

Another object of the present invention is to provide a frame for casings, doors or windows and the like that uses low-quality wood without compromising the technical characteristics that said frame is required to have.

A further object of the present invention is to provide a frame for casings, doors or windows and the like that allows to reduce production costs with respect to productions currently in use.

Another object of the present invention is to provide a frame for casings, doors or windows and the like that allows to eliminate wood reserves and therefore capital tie-up, at the same time reducing the risks of damage on the part of woodworm, cracking, marking and fire.

A still further object of the present invention is to provide a method for producing frames for casings, doors or windows and the like that allows to manufacture, with low industrial costs, frames that are extremely strong and stable from a geometric and structural standpoint.

This aim and these and other objects that will become better apparent hereinafter are achieved by a frame for casings, doors or windows and the like, comprising a base framework constituted by at least two wood layers that are mutually bonded by gluing, characterized in that each layer is formed by at least one longitudinal series of wood tiles that are mutually connected by means of so-called finger joints.

### BRIEF DESCRIPTION OF THE DRAWINGS

Further characteristics and advantages of the present invention will become better apparent from the following detailed description of a preferred but not exclusive embodiment thereof, illustrated by way of non-limiting example in the accompanying drawings, wherein:

FIG. 1 is a perspective view of a portion of a frame according to the invention;

FIG. 2 is a perspective view of a cutout of a frame of a window sash according to the invention, with the corresponding casing frame, also according to the invention;

FIG. 3 is a perspective view of a cutout of a frame of a parallel matchboard shutter according to the invention;

FIG. 4 is a plan view of a door mounting frame according to the invention, with cutouts illustrating different layers;

FIG. 5 is a perspective view of a cutout of a door sash frame according to the invention.

### DESCRIPTION OF THE PREFERRED EMBODIMENTS

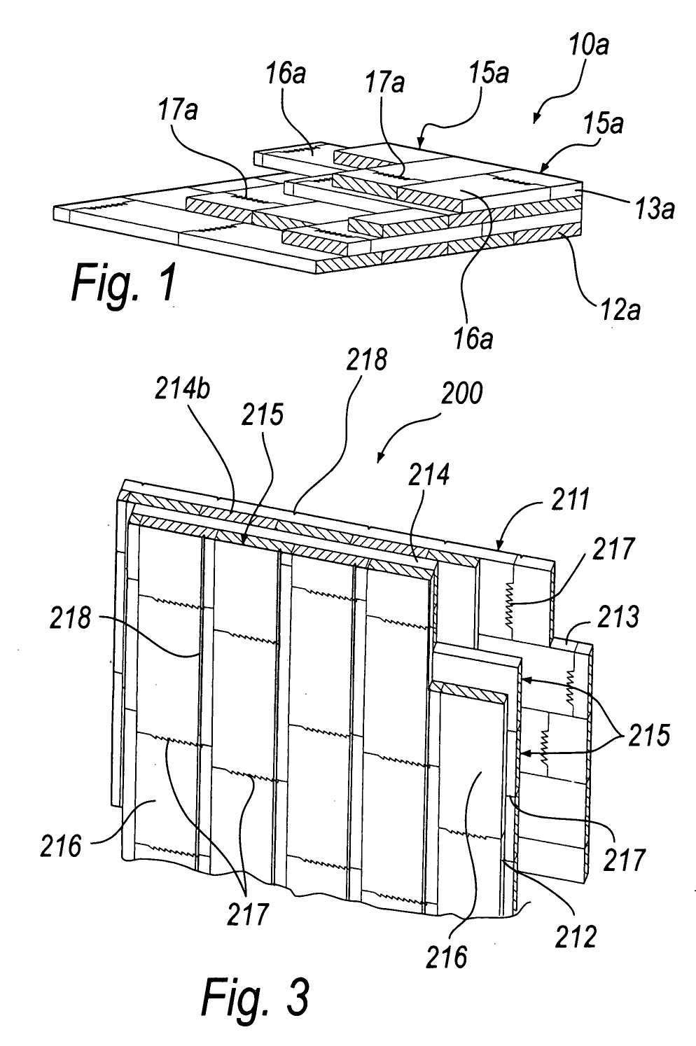

With reference to FIG. 1, a portion of the frame for casings, doors or windows and the like according to the invention is generally designated by the reference numeral 10a.

Such frame portion 10a comprises part of a base framework 11a, which is constituted by four layers of wood (with an inner layer 12a and an outer layer 13a), which are mutually bonded by gluing.

Each layer is formed by at least one longitudinal series 15a of wood tiles 16a, which are mutually connected by means of so-called finger joints 17a.

A plurality of embodiments of the frame according to the invention is described hereinafter.

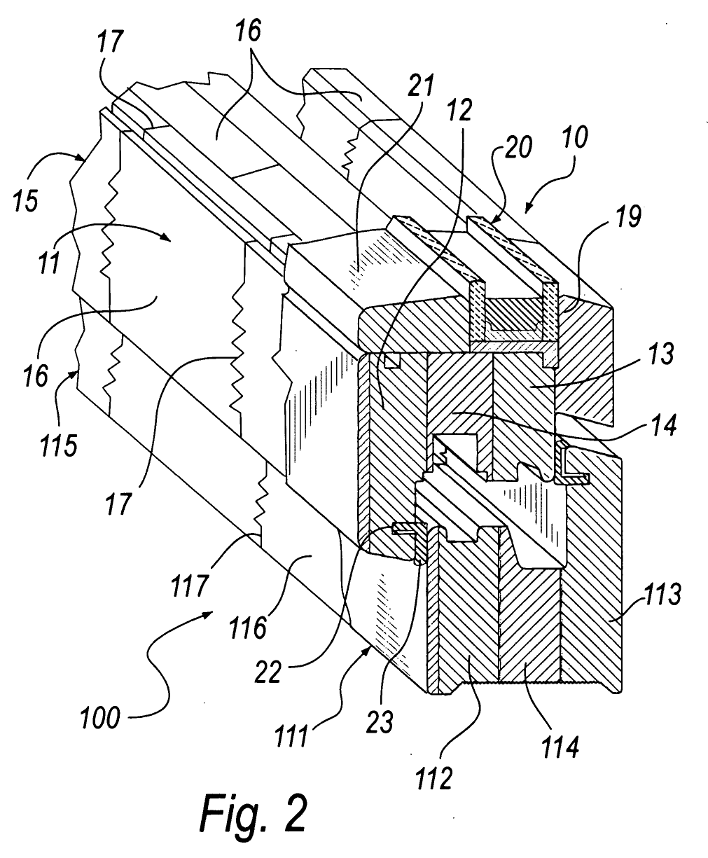

With reference to FIG. 2, a first frame according to the invention, related to a window sash, is generally designated by the reference numeral 10, and the reference numeral 100 designates a second frame according to the invention, related to a window casing against which the first frame 10 abuts.

The first frame 10 comprises a base framework 11, which is constituted by three wood layers that are mutually bonded by gluing: respectively, an inner layer 12, an outer layer 13, and a central layer 14, which is sandwiched between the layers 12 and 13.

Each layer is formed by a longitudinal series 15 of wood tiles 16, which are mutually connected by means of so-called finger joints 17.

The finger joints 17 are constituted by contoured portions provided with wedge-shaped teeth and by complementary contoured portions that are provided respectively on the leading edge of a tile 16 and on the trailing edge of the adjacent tile.

The tiles 16 of a longitudinal series 15 are generally staggered with respect to the adjacent tiles of each contiguous layer, so that joints 17 related to different layers are mutually spaced.

A fourth layer 18 is bonded by gluing to the outer layer 13; it is narrower than the outer layer 13 and acts as a shelter for a gasket located in a lower region on the second frame 100.

The layer 18 also is formed by a longitudinal series of tiles 16.

The fourth layer 18 protrudes, parallel to the plane of the window, by means of a portion 19 with respect to the other three layers 12, 13 and 14 and acts as an abutment for a double-glazing unit 20.

The double-glazing unit 16 is sandwiched between the portion 19 and a rim 21 that is fixed to the inner layer 12.

Various machinings, such as for example a groove 22 on the inner layer 12 for the insertion of a gasket 23, are provided on the longitudinal series 15.

In this embodiment, an exposed finishing veneer 24 of high-value wood (for example oak, chestnut, birch, rift-sawn fir, larch or mahogany) or very high-value wood (for example teak, rosewood, et cetera) is made to adhere to the inner face of the inner layer 12.

The thickness of said veneer can be for example 3-4 mm.

Likewise, the second frame 100, related to a window casing, comprises a base framework 111 that is constituted by three wood layers that are mutually bonded by gluing: respectively, an inner layer 112, an outer layer 113, and a central layer 114, which is sandwiched between the layers 112 and 113.

Each layer is formed by a longitudinal series 115 of wood tiles 116, which are mutually connected by means of finger joints 117.

The tiles 116 of a longitudinal series 115 are generally staggered with respect to the adjacent tiles of each contiguous layer, so that joints 117 related to different layers are mutually spaced.

As in the first frame 10, an exposed finishing veneer 124 of high-value wood is made to adhere to the inner face of the inner layer 112.

With reference to FIG. 3, a further embodiment of the invention relates to a third frame 200 related to a parallel matchboard shutter.

Like the other two frames 10 and 100 described above, such third frame 200 comprises a base framework 211, which is constituted by four layers of wood that are mutually bonded by gluing: respectively, an inner layer 212, an outer layer 213, and a first central layer 214a that is coupled to a second central layer 214b; the central layers 214 are sandwiched between the layers 212 and 213.

Each one of the wood layers 212, 213, 214 is formed by a plurality of parallel and adjacent longitudinal series 215 of wood tiles 216 (in practice, each longitudinal series 215 forms said parallel matchboard elements).

The wood tiles 216 are mutually connected by means of finger joints 217.

The finger joints 217 are constituted by contoured portions with wedge-shaped teeth and corresponding complementary contoured portions provided respectively on the leading edge of a tile 216 and on the trailing edge of the contiguous tile.

In a same layer 212, 213, 214 contiguous tiles 216 are provided that belong respectively to mutually adjacent longitudinal series 215, which are mutually staggered.

In practice, the tiles 216 of a longitudinal series of a given layer are staggered with respect to the contiguous tiles of an adjacent longitudinal series, so that joints 217 related to adjacent longitudinal series (of a same layer) are mutually spaced.

The longitudinal series 215 of wood tiles 216 related to a layer are arranged so that their longitudinal dimension is at right angles to the corresponding longitudinal series of the contiguous layer.

Both the outer layer 212 and the inner layer 214 have vertical grooves 218.

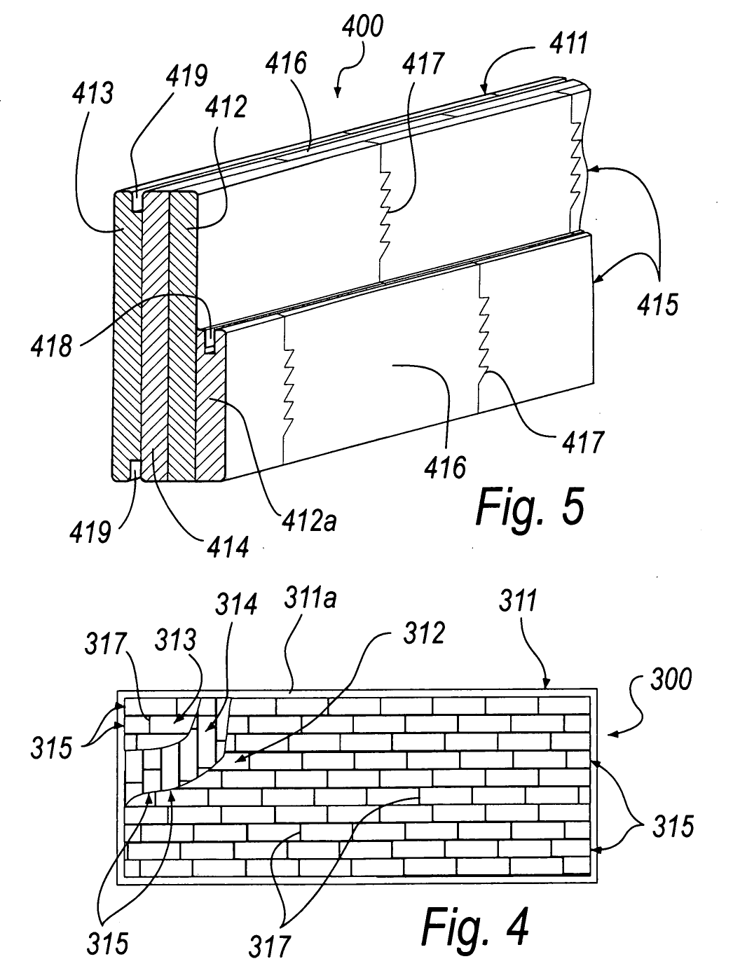

With reference to FIG. 4, another embodiment of the invention relates to a fourth frame 300 related to a door sash.

Like the third frame 200 described above, such fourth frame comprises a base framework 311 so as to form a panel enclosed by a rim 311a.

As described above, the base framework 311 is constituted by three layers of wood that are mutually bonded by gluing: respectively, an inner layer 312, an outer layer 313, and a central layer 314 that is sandwiched between the layers 312 and 313.

Each one of said wood layers 312, 313 and 314 is formed by a plurality of mutually parallel and adjacent longitudinal series 315 of wood tiles 316.

The wood tiles 316 are mutually connected by means of finger joints 317.

The structure and arrangement of the longitudinal series 315 is substantially the same as that of the third frame 200 described above.

In practice, the tiles 316 of adjacent longitudinal series of each layer are mutually staggered, while the longitudinal series of each layer are arranged at right angles to those of each contiguous layer.

With reference to FIG. 5, another embodiment of the invention relates to a fifth frame 400 related to a door mounting frame.

Like the second frame 100 described above, this frame comprises a base framework 411, which is constituted by three layers of wood that are mutually bonded by gluing: respectively, an inner layer 412, an outer layer 413, and a central layer 414 that is sandwiched between the layers 412 and 413.

Moreover, the fifth frame comprises a fourth wood layer 412a, which is glued to the inner layer 412 but is narrower, so as to form the edge of the wing.

Each layer is formed by a longitudinal series 415 of wood tiles 416, which are mutually connected by means of finger joints 417.

The tiles 416 of a longitudinal series 415 are generally staggered with respect to the adjacent tiles of each contiguous layer, so that joints 417 related to different layers are mutually spaced.

The fourth layer 412a is provided with a longitudinal groove 418 for the insertion of a gasket (not shown).

The outer layer 414 also has two grooves 419 on opposite sides.

In general, the width of the tiles 16, 116, 216 et cetera is substantially constant for each longitudinal series 15, 115, 215 et cetera and is generally constant also on the entire framework; the tiles related to the peripheral region of the framework 11, 111, 211 et cetera may have different dimensions.

In these embodiments, the length of the tiles 16, 116 et cetera is substantially comprised between 15 and 30 cm.

The wood that constitutes the tiles is of the type that is dried with a residual humidity comprised between 9 and 11%.

A method for providing frames for casings, doors or windows and the like, as described above by way of example, consists in dividing a wood board into substantially rectangular wood tiles, rejecting substantially rectangular portions of said boards in which there are imperfections of the wood, such as for example knots.

The leading edge of each wood tile is then shaped so as to form wedge-like teeth, and the trailing edge of each wood tile is then shaped complementarily to the contour of said leading edge.

The leading and trailing edges of a plurality of wood tiles are then joined with the addition of adhesive so as to form a longitudinal series of wood tiles of preset length.

Such longitudinal series of wood tiles is planed and calibrated.

At this point, several of said longitudinal series of wood tiles are composed by using adhesive, both by overlapping and by side-by-side arrangement, so as to form at least part of the frame.

In particular, when the frame is formed by several parts, such as for example in the case of window sashes, window casings, doors mounting frames, et cetera, which are generally composed of uprights and cross-members that are mutually joined, the method provides for the forming of said parts, optionally for their shaping and then for their mutual connection; the resulting frame can be then reworked so as to provide new contoured regions.

If the frame is formed by a single part, as in the case of doors, shutters et cetera, which are generally composed of a panel-like framework, the method forms said part and shapes it according to requirements.

In practice it has been found that the invention thus described solves the drawbacks noted in known types of frame for casings, doors or windows and the like.

It should be noted that the elimination of the defects and discontinuities provided by the finger jointing process increases and uniformly distributes the mechanical strength values of the frame according to the invention.

Moreover, the overlap of the tiles, which are staggered longitudinally and by arranging the contiguous layers at right angles to each other, eliminates the characteristic anisotropy of wood.

Moreover, a frame according to the invention provides a considerable saving in working time: filling is eliminated, sanding times are reduced, and work is performed with programmable machine tools.

The frame according to the invention has an extremely high rigidity and geometric and structural stability even with low-quality wood.

The invention thus conceived is susceptible of numerous modifications and variations, all of which are within the scope of the appended claims; all the details may further be replaced with other technically equivalent elements.

In practice, the materials employed, so long as they are compatible with the specific use, as well as the dimensions, may be any according to requirements and to the state of the art.

The disclosures in Italian Utility Model Application No. PD2003U000033 from which this application claims priority are incorporated herein by reference.

What is claimed is:

1. A frame for casings, doors or windows, comprising: a base framework constituted by at least two wood layers that are mutually bonded by gluing, with each layer being constituted by at least one longitudinal series of wood tiles, said wood tiles comprising contoured portions that are shaped in a complementary manner so as to provide finger joints that connect to each other said wood tiles.

2. The frame of claim 1, comprising wood tiles of said at least one longitudinal series of wood tiles arranged so as to be staggered with respect to adjacent tiles of each contiguous layer.

3. The frame of claim 2, wherein each one of said at least two wood layers bonded together by gluing is formed by at least two longitudinal series of wood tiles, which are mutually adjacent, with contiguous wood tiles being provided in a same layer and belonging respectively to adjacent longitudinal series, which are mutually staggered.

4. The frame of claim 3, wherein each longitudinal series of wood tiles is arranged transversely with respect to an extension of the longitudinal series of wood tiles of each contiguous layer.

5. The frame of claim 4, wherein each longitudinal series of wood tiles is arranged at right angles to an extension of the longitudinal series of wood tiles of each contiguous layer.

6. The frame of claim 1, wherein said contoured portions forming said finger joints comprise teeth that are wedge-shaped.

7. The frame of claim 1, wherein the wood that constitutes said at least two wood layers that are mutually bonded by gluing is dried wood with a residual humidity comprised between 9 and 11%.

8. The frame of claim 1, wherein said wood tiles have a length comprised substantially between 15 and 30 cm.

9. The frame of claim 1, comprising an exposed finishing veneer of high-quality wood that is adhered to an inner face of said frame.

10. A method for producing frames for casings, doors or windows, comprising the steps of: dividing a wood board into substantially rectangular wood tiles and rejecting substantially rectangular portions of said boards containing wood imperfections; shaping a leading edge of each wood tile so as to form a contour portion with wedge-shaped teeth; shaping a trailing edge of each wood tile complementarily to the contour portion of said leading edge; joining, with addition of adhesive, leading and trailing edges of a plurality of wood tiles so as to form a longitudinal series of wood tiles of preset length; planing and calibrating said longitudinal series of wood tiles; composing, by connecting with adhesive, several of said longitudinal series of wood tiles by arranging side-by-side and overlapping said wood tiles, so as to form at least part of a frame for casings, doors or windows; and shaping according to requirements said at least part of the frame.

11. The method of claim 10, wherein said frame is produced composed of at least two parts that are formed by several of said longitudinal series of wood tiles, the method further comprising, after the step for composing several of said longitudinal series of wood tiles so as to form said at least two parts that compose said frame, a step for shaping said at least two parts and a step for joining said at least two parts.

12. The method of claim 11, comprising, after said step for joining said at least two parts, a step for a further shaping of said frame formed by joining said at least two parts.

13. The method of claim 10, wherein said frame is produced composed of a single part that is formed by several of said longitudinal series of wood tiles, the method further comprising, after the step for composing several of said longitudinal series of wood tiles so as to form said part that composes said frame, a step for shaping said frame.
